(19) United States
(12) Patent Application Publication
(10) Pub. No.: US 2002/0089816 A1
(43) Pub. Date: Jul. 11, 2002

(54) Keyboard device capable of driving removable recording medium

(76) Inventors: Tetsuya Mizoguchi, Hino-shi (JP); Masao Suga, Ome-shi (JP)

Correspondence Address: Finnegan, Henderson, Farabow,, Garrett & Dunner, L.L.P., 1300 I Street, N.W., Washington, DC, 20005-3315, US

(21) Appl. No.: 10/028,334

(22) Filed: Dec. 28, 2001

(30) Foreign Application Priority Data
Dec. 28, 2000 (JP) 2000-401629

(51) Int. Cl. G06F 1/16

(52) U.S. Cl. 361/680; 361/683

(57) ABSTRACT

A keyboard device is provided with not only a number of keys thereon that are arranged in a known manner but also a disk drive for driving an optical disc in a cartridge and a display section including an indicator for notifying the user of the current status of operation of the optical disc in the disk drive. The disk drive is arranged at a rear and lower position of a lateral side of the keyboard device and therefore the optical disc in the disk drive is minimally affected by any vibrations that may take place while the optical disc is driven. Additionally, since the disk drive is placed in a space produced from a tilted arrangement of the keyboard device, it does not require any additional space to be provided for it.

### CROSS-REFERENCE TO RELATED APPLICATIONS

This application is based upon and claims the benefit of priority from the prior Japanese Patent Application No. 2000-401629, filed Dec. 28, 2000, the entire contents of which are incorporated herein by reference.

### BACKGROUND OF THE INVENTION

1. Field of the Invention

The present invention relates to a keyboard device capable of exchanging data with a computer main body.

2. Description of the Related Art

In recent years, personal computers are available in various different forms adapted to respective applications and include those of the desktop type, those of the notebook type and those of the sub-notebook type as well as those that can be used as mobile information terminals.

Of these, desktop type personal computers have a number of units including a computer main body, a display device and a keyboard device that are combined to operate as a system. The computer main body of a desktop type personal computer is normally provided with one or more drives for driving respective recording media that are externally loaded. In general, the drives in the computer main body for removable media typically include a floppy disk drive for driving a floppy disk inserted to a slot thereof and a CD-ROM drive for driving a CD-ROM loaded using a tray.

Thus, the user of a desktop type personal computer can cause it to appropriately read data from and write data to a floppy disk and/or a CD-ROM that are external recording media.

However, the number of types of removable recording medium that the computer main body can handle is normally quite limited. Therefore, if the user wants to use a removable recording medium of a type other than those that the main body is designed to handle (e.g., a floppy disk and a CD-ROM), he or she has to provide a drive adapted to the recording medium and connect it to the computer main body by way of a cable and a corresponding interface.

Consequently, the system configuration may become complex because of the additional cable and other elements that can occupy a large space to damage the environment of the user working at the computer.

In view of the above identified circumstances, it is therefore desirable to provide the user with an environment where data processing operations are centered at the keyboard located close to the user and conducted effectively and efficiently if he or she uses a removable recording medium of any new type.

Jpn. Pat. Appln. KOKAI Publication No. 9-34613 discloses a keyboard incorporating an exchangeable expansion board or a PC card slot. According to this document, however, a connector is merely connected to the PC card slot, so that it is impossible to use a cartridge containing a disciform recording medium such as an optical disc capable of recording a large amount of data.

### BRIEF SUMMARY OF THE INVENTION

Accordingly, it is an object of the present invention to provide a keyboard device that is adapted to effectively and efficiently process data with a removable recording medium.

According to one aspect of the present invention, there is provided a keyboard device capable of exchanging data with a computer main body, the device comprising: a disk drive including a slot configured to receive an insertion of a cartridge containing a disciform recording medium having recording surface on both sides, the slot being capable of receiving the disciform recording medium even if the disciform recording medium is turned upside down, and a carriage having a head and pivoting an arc to read data from or writing data to the recording surface of the disciform recording medium via the head; and a controller configured to control the disk drive.

According to another aspect of the present invention, there is provided a keyboard device capable of exchanging data with a computer main body, the device comprising: a keyboard controller; a first USB controller connected to the keyboard controller and capable of being connected to a USB controller in the computer main body; a disk drive including a slot configured to receive an insertion of a cartridge containing a disciform recording medium having recording surface on both sides, the slot being capable of receiving the disciform recording medium even if the disciform recording medium is turned upside down, and a carriage having a head and pivoting an arc to read data from or writing data to the recording surface of the disciform recording medium via the head; a disk drive controller configured to control the disk drive; and a second USB controller connected to the disk drive controller, the second USB controller being hub-connected to the first USB controller.

According to still another aspect of the present invention, there is provided a keyboard device capable of exchanging data with a computer main body, the device comprising: a keyboard controller; a Bluetooth controller connected to the keyboard controller and capable of being connected to a Bluetooth controller in the computer main body; a disk drive including a slot configured to receive an insertion of a cartridge containing a disciform recording medium having recording surface on both sides, the slot being capable of receiving the disciform recording medium even if the disciform recording medium is turned upside down, and a carriage having a head and pivoting an arc to read data from or writing data to the recording surface of the disciform recording medium via the head; and a disk drive controller configured to control the disk drive, the disk drive controller being connected to the Bluetooth controller that is connected to the keyboard controller.

According to still another aspect of the present invention, there is provided a keyboard device capable of exchanging data with a computer main body, the device comprising: a slot configured to receive an insertion of a card containing a disk drive and a disciform recording medium driven by the disk drive; and a controller configured to control the card.

According to still another aspect of the present invention, there is provided a keyboard device capable of exchanging data with a computer main body, the device comprising: a keyboard controller; a first USB controller connected to the keyboard controller and capable of being connected to a USB controller in the computer main body; a slot configured to receive an insertion of a card containing a disk drive and a disciform recording medium driven by the disk drive; a card controller configured to control the card; and a second USB controller connected to the card controller, the second USB controller being hub-connected to the first USB controller.

According to still another aspect of the present invention, there is provided a keyboard device capable of exchanging data with a computer main body, the device comprising: a keyboard controller; a Bluetooth controller connected to the keyboard controller and capable of being connected to a Bluetooth controller in the computer main body; a slot configured to receive an insertion of a card containing a disk drive and a disciform recording medium driven by the disk drive; and a card controller configured to control the card, the card controller being connected to the Bluetooth controller that is connected to the keyboard controller.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic perspective view of a desktop type computer system according to first to third embodiments of the present invention;

FIGS. 2A and 2B are schematic illustrations of a DataPlay™ digital medium that is used in the same embodiments and a disk drive for driving it;

FIG. 3 is a schematic lateral view illustrating the location of the disk drive of the keyboard device 1 according to the same embodiments;

FIG. 4 is a view illustrating in detail the display section of the keyboard device according to the same embodiments;

FIG. 5 is a schematic block diagram illustrating the internal configuration of the keyboard device according to a first embodiment of the present invention;

FIG. 6 is a flowchart showing the operation of the keyboard device according to the same embodiment;

FIG. 7 is a schematic block diagram illustrating the internal configuration of the keyboard device according to a second embodiment of the present invention;

FIG. 8 is a flowchart showing the operation of the keyboard device according to the same embodiment;

FIG. 9 is a schematic block diagram illustrating the internal configuration of the keyboard device according to a third embodiment of the present invention;

FIG. 10 is a flowchart showing the operation of the keyboard device according to the same embodiment;

FIG. 11 is a schematic perspective view of a desktop type computer system according to fourth to sixth embodiments of the present invention;

FIGS. 12A and 12B are schematic illustrations of PC cards that are used in the same embodiments;

FIG. 13 is a schematic lateral view illustrating the location of the PC card slot of the keyboard device according to the same embodiments;

FIG. 14 is a view illustrating in detail the display section of the keyboard device according to the same embodiments;

FIG. 15 is a schematic block diagram illustrating the internal configuration of the keyboard device according to a fourth embodiment of the present invention;

FIG. 16 is a flowchart showing the operation of the keyboard device according to the same embodiment;

FIG. 17 is a schematic block diagram illustrating the internal configuration of the keyboard device according to a fifth embodiment of the present invention;

FIG. 18 is a flowchart showing the operation of the keyboard device according to the same embodiment;

FIG. 19 is a schematic block diagram illustrating the internal configuration of the keyboard device according to a sixth embodiment of the present invention; and

FIG. 20 is a flowchart showing the operation of the keyboard device according to the same embodiment.

### DETAILED DESCRIPTION OF THE INVENTION

The embodiments of the present invention will be described below with reference to the drawings.

According to first to third embodiments, keyboard devices capable of executing data processing for a DataPlay™ digital medium (to be referred to simply as DataPlay hereinafter) will be explained. On the other hand, according to fourth to sixth embodiments, keyboard devices capable of executing data processing for a PC card will be explained.

### 1st Embodiment

Now, the first embodiment of the present invention will be described below.

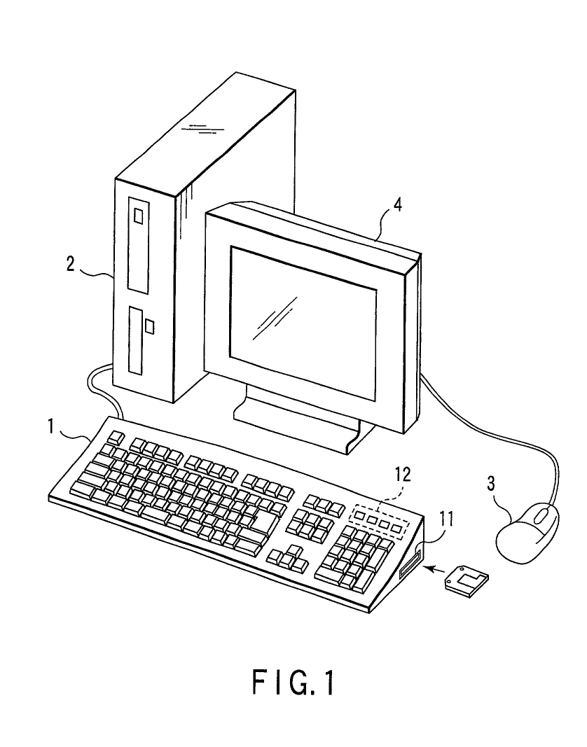

FIG. 1 is a schematic perspective view of a desktop type computer system according to a first embodiment of the present invention. Note, however, that the illustrated computer system can also be used in second and third embodiments of the present invention, which will be described later.

The computer system includes a keyboard device 1, a computer main body 2, a mouse 3 and a display unit 4.

The keyboard device 1 is an input device through which the user inputs data. The keyboard device 1 is provided with not only a number of keys thereon that are arranged in a known manner but also a disk drive 11 for driving a DataPlay and a display section 12 including an indicator (lamp) for notifying the user of the current status of operation of the optical disc of DataPlay in the disk drive 11 as characteristics of this embodiment. The keyboard device 1 is connected to the computer main body 2 by way of a USB cable compatible with a USB (universal serial bus).

DataPlays that can be loaded into the disk drive 11 include ordinary DataPlays and those for security purposes (optional discs) that are used when the user's key input needs to be invalidated.

The computer main body 2 contains therein a computer that controls the entire system and a hard disk drive, along with drives for driving respective removable recording media such as a floppy disk and a CD-ROM. The computer main body carries out a known process for displaying information on the display unit 4 in accordance with signals coming from the keyboard device 1 but also a process of (reading data from and writing data to) the DataPlay in the disk drive 11 of the keyboard device 1.

The mouse 3 is also an input device that the user uses for data input operations and is connected to the computer main body 2 by way of a cable. The display unit 4 is adapted to display various pieces of information and is connected to the computer main body 2 by way of a cable.

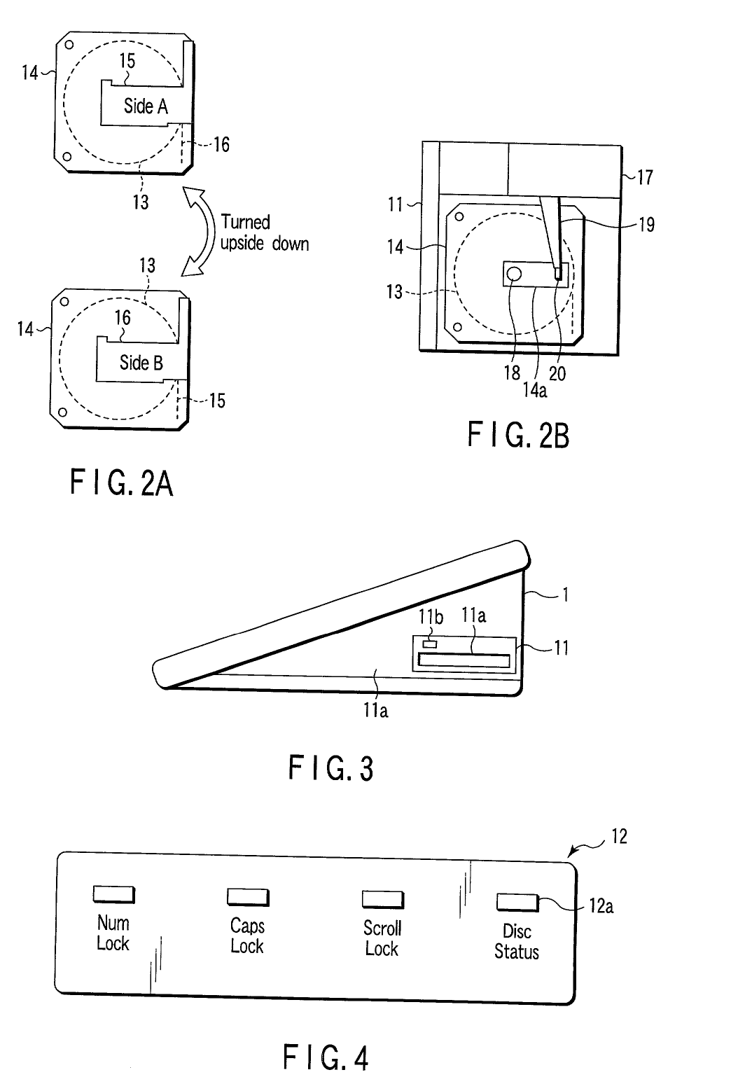

FIGS. 2A and 2B are schematic illustrations of a DataPlay that is used in the same embodiment and a disk drive 11 for driving it.

A DataPlay is a recording medium available from DataPlay, Inc. As shown in FIG. 2A, it includes a cartridge (e.g., plastic case) 14 and an optical disc 13 (disciform recording medium) contained in the cartridge 14. The optical disc 13 can store various digital contents (video data, audio data, document data, computer programs, etc.).

The optical disc 13 can store data on both sides thereof (side A and side B). When the user wants to use side A, he or she inserts the cartridge 14 into the disk drive 11 with side A facing upward. When, on the other hand, the user wants to use side B, he or she inserts the cartridge 14 into the disk drive 11 with side B facing upward.

The cartridge 14 is provided with a window located at a position facing side A of the optical disc 13 and a shutter 15 for covering the window. The window facing side A can be opened by operating the shutter 15. Similarly, the cartridge 14 is provided with another window located at a position facing side B of the optical disc 13 and a shutter 16 for covering the window. The window facing side B can be opened by operating the shutter 16.

The DataPlay shown in FIG. 2A may be one to be used to invalidate the pending key input by the user for security purposes. For instance, when multimedia data is retrieved from an ordinary DataPlay by means of this system, the user can load the data stored in a security-purpose DataPlay to unlock the input keys on the keyboard device 1 in advance so that the succeeding data retrieval operation may not be obstructed.

The disk drive 11 shown in FIG. 2B has a structure adapted to load the DataPlay (cartridge 14 containing an optical disc 13) inserted from the outside by way of the corresponding slot. As the DataPlay is loaded, the disk drive 11 opens one of the windows (facing side A and side B respectively), the window 14a (located closer to the head 20), of the cartridge 14 in response to an action of operating the corresponding one of the shutters (not shown in FIG. 2B). Under this condition, the control section 17 of the disk drive 11 drives the optical disc 13 by means of the rotary mechanism 18 thereof and, at the same time, moves the head 20 (pivots an arc) to the target position of the surface of the disc to read data from or write data to the optical disc by operating the carriage 19.

While the embodiment is described here in terms of a DataPlay that is made to rotate by the disk drive, it may be replaced by some other recording medium conforming to some other standard, if it is adapted to be made to rotate.

FIG. 3 is a schematic lateral view illustrating the location of the disk drive 11 of the keyboard device 1 according to the same embodiment.

As shown in FIG. 3, the disk drive 11 is arranged at a rear and lower position of a lateral side of the keyboard device 1. With such a positional arrangement, the DataPlay is minimally affected by any vibrations that may take place while the DataPlay is driven.

Additionally, since the disk drive is placed in a space produced from the tilted arrangement of the keyboard device, it does not require any additional space to be provided for it. Furthermore, the disk drive does not provide any obstruction relative to the cables and the antenna of the computer system nor aesthetically damage the appearance of the computer system.

The disk drive 11 is provided with a slot 11a for receiving a DataPlay and a DataPlay lock/release button 11b. Since the hands of the user operating the computer system are normally placed on the keyboard device and the disk drive 11 is located very close to one of the hands of the user, the above positional arrangement of the disk drive 11 is very convenient to the user when he or she inserts or takes out the DataPlay.

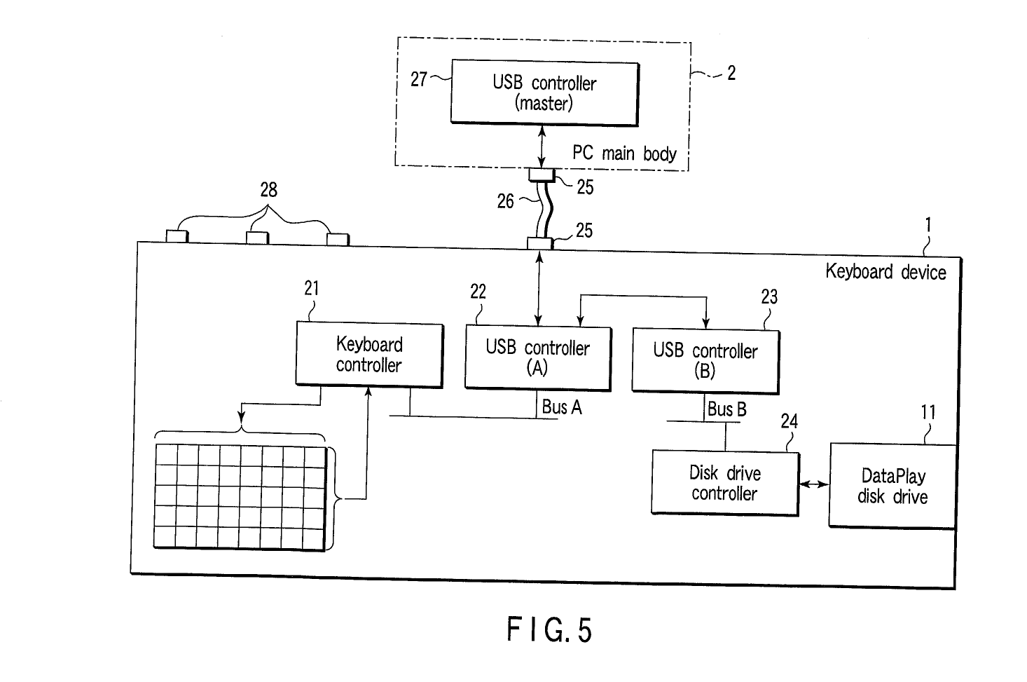

FIG. 4 is a view illustrating in detail the display section 12 of the keyboard device 1 according to the same embodiment.

As shown in FIG. 4, the display section 12 of the keyboard device 1 is provided with indicators corresponding respectively to the features of NumLock, CapsLock and ScrollLock as well as a disc status indicator 12a for notifying the user of the status of the optical disc of the DataPlay in the disk drive 11. The indicator 12a may typically flash when the DataPlay is accessed by means of the disk drive 11.

FIG. 5 is a schematic block diagram illustrating the internal configuration of the keyboard device according to a first embodiment of the present invention.

Referring to FIG. 5, a keyboard controller 21 of the keyboard device 1 is connected to a bus A and controls the input keys (keyboard) of the keyboard device 1. When one or more of the input keys (keyboard) is depressed, the keyboard controller 21 transmits corresponding data to the PC main body 2 by way of the bus A and USB controller (A) 22. When, on the other hand, it receives a signal for invalidating the key input by way of the USB controller (A) 22 and the bus A, it controls the operation of the keyboard so as to invalidate the key input.

The USB controller (A) 22 is also connected to the bus A and provided with a functional feature of operating as a hub for controlling a keyboard conforming to the USB Standard. The USB controller (A) 22 is also connected to a USB controller (master) 27 arranged in the PC main body 2 by way of USB connectors 25 and USB cable 26. The USB controller (A) 22 is additionally connected to another USB controller (B) 23 having a functional feature similar to that of the USB controller (A) 22 for inter-hub connection so that they may communicate with each other. Thus, the USB controller (A) 22 is adapted to handle exchanges of data between the keyboard controller 21 and the USB controller 27, between the USB controller 27 and the USB controller (B) 23 and between the USB controller (B) 23 and the keyboard controller 21.

The USB controller (B) 23 is connected to bus B and provided with a functional feature of operating as a hub for controlling the DataPlay conforming to the USB Standard. The USB controller (B) 23 is additionally connected to the USB controller (A) 22 for inter-hub connection so that they may communicate with each other. Thus, the USB controller (B) 23 is adapted to handle exchanges of data between the USB controller (A) 22 and the disk drive controller 24 on the bus B.

The disk drive controller 24 is connected to the bus B and adapted to control the operation of the DataPlay in the disk drive 11. Upon receiving a request for accessing the DataPlay from the PC main body 2 by way of the USB controller (A) 22 and the USB controller (B) 23, the disk drive controller 24 reads data from or writes data to the DataPlay and, if necessary, transmits data on the DataPlay to the PC main body 2 by way of the USB controller (A) 22 and the USB controller (B) 23.

The USB connectors 25 and the USB cable 26 shown in FIG. 5 are provided to connect the USB controller (A) arranged in the keyboard device 1 and the USB controller 27 of the PC main body 2 according to the USB Standard.

The USB controller 27 is arranged in the PC main body 2 and adapted to operate as master conforming to the USB Standard. The USB controller 27 is connected to the USB controller (A) 22 arranged in the keyboard device 1 by way of the USB connectors 25 and the USB cable 26. With this connection arrangement, the USB controller 27 is adapted to handle exchanges of data with the keyboard controller 21 and also with the disk drive controller 24.

Connectors 28 of different types are provided for the purpose of connecting the keyboard device 1 to external devices conforming to respective interface standards. For instance, one of them may be used to connect the keyboard device 1 to a digital camera or the like for the purpose of exchanging data between the DataPlay in the disk drive 11 and the digital camera. The connectors 28 may include one or more USB connectors adapted to connect the keyboard device 1 to some other USB devices.

The keyboard device 1 is fed with power from the PC main body by way of the USB cable 26.

As described above, the keyboard device 1 contains a number of hubs (the USB controller (A) 22 and the USB controller (B) 23) so that data may be exchanged between the keyboard controller 21 or the disk drive controller 24 of the keyboard device 1 and the USB controller 27 of the PC main body 2.

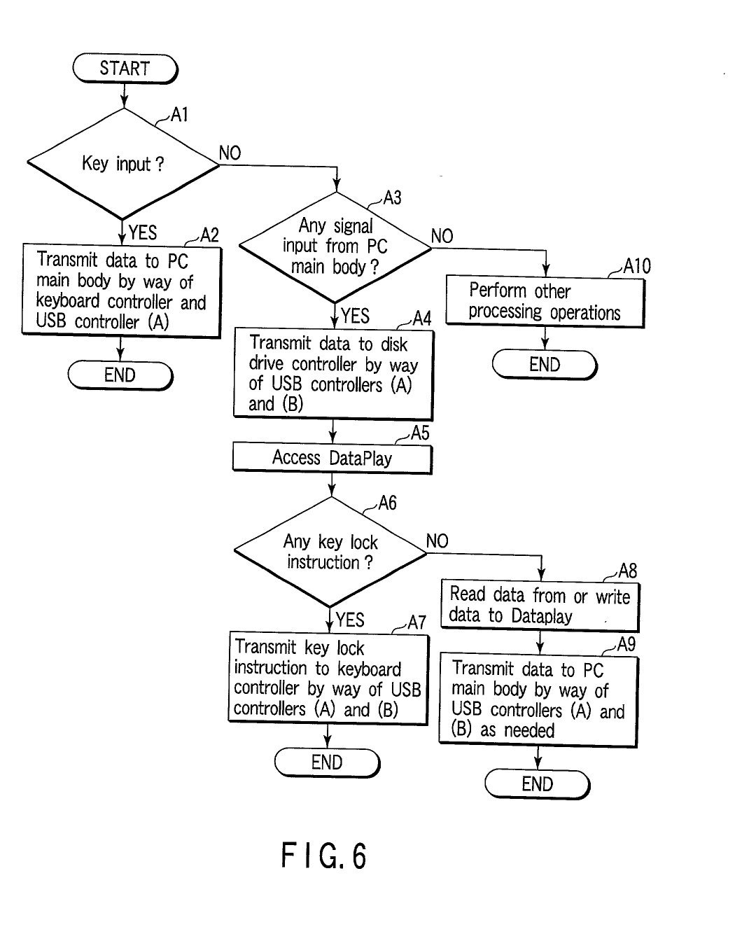

Now, the operation of the keyboard device according to the first embodiment will be described by referring to the flowchart of FIG. 6.

When a user key input operation takes place (Step A1), the corresponding data is transmitted from the keyboard controller 21 to the USB controller (A) 22 by way of the bus A and also to the PC main body 2 by way of the USB connectors 25 and the USB cable 26 (Step A2). As a result, the data input by the user is transmitted to the PC main body 2.

When, on the other hand, an access request signal for accessing the DataPlay is transmitted from the PC main body 2 to the USB controller (A) 22 by way of the USB connectors 25 and the USB cable 26 (Step A3), the corresponding data is transmitted from the USB controller (A) 22 to the USB controller (B) 23 and further to the disk drive controller 24 by way of the bus B (Step A4).

As a result, the DataPlay in the disk drive 11 is accessed by the disk drive controller 24 (Step A5).

If the accessed DataPlay is a security-purpose DataPlay and hence a key lock instruction is detected (Step A6), the disk drive controller 24 notifies the keyboard controller 21 of the data representing the instruction by way of the bus B, the USB controller (B) 23, the USB controller (A) 22 and the bus A (Step A7). As a result, the key input of the user is invalidated by the keyboard controller 21.

If, on the other hand, the DataPlay accessed in Step A6 is an ordinary DataPlay and hence no key lock instruction is detected, the optical disc in the cartridge of the DataPlay is made to rotate and the data at the target recording position is read out or data is written to the target recording position under the control of the disk drive controller 24 (Step A8). If necessary, appropriate data stored in the DataPlay may be transmitted to the PC main body 2 by way of the bus B, the USB controller (B) 23, the USB controller (A) 22, the USB connectors 25 and the USB cable 26 (Step A9).

Also, if necessary, some other processing operation (e.g., exchange of data with an external device by way of one of the connectors 28) may be conducted (Step A10).

While the system incorporating the first embodiment includes controllers, connectors and a cable conforming to the USB Standard in the above description, the controllers, the connectors and the cables may alternatively conform to the IEEE1394 Standard or some other appropriate standard. The above description of the processing procedure may equally apply if such alternative components are used.

While a pair of hubs is provided in the embodiment of the keyboard device in the above description, the embodiment is not limited thereto and three or more than three hubs may alternatively be provided to expand the functional scope of the embodiment.

Thus, with the first embodiment of the keyboard device including a plurality of hubs, the use of a single cable is sufficient for exchanges of data between the keyboard device and the PC main body to simplify the system configuration and reduce the cost.

Additionally, as a keyboard device that is relatively less apt to be influenced by external vibrations is adapted to handle a DataPlay in the embodiment, a disk drive including a disc, an arm, a suspension system and a head that are highly sensitive to vibrations can safely be used in the keyboard device.

Further, since the disk drive is arranged at a rear and lower position of a lateral side of the keyboard device 1, the optical disc in the cartridge of the DataPlay is minimally affected by any vibrations that may take place while the DataPlay is driven.

Further still, since the disk drive is placed in a space produced from the tilted arrangement of the keyboard device, it does not require any additional space to be provided for it. Furthermore, the disk drive does not provide any obstruction relative to the cables and the antenna of the computer system nor aesthetically damage the appearance of the computer system.

Since the hands of the user operating the computer system are normally placed on the keyboard device and the disk drive is located very close to one of the hands of the user, the above positional arrangement of the disk drive is very convenient to the user when he or she inserts or takes out the DataPlay.

Finally, since a DataPlay is a relatively small removable recording medium, the space occupied by the disk drive in the keyboard device can be minimized.

### 2nd Embodiment

Next, the second embodiment of the present invention will be described below.

While the first embodiment includes USB controllers conforming to the USB Standard, and a computer system formed by using the first embodiment is described above, the second embodiment includes a Bluetooth™ controller, and a computer system formed by using the second embodiment will be described below.

A computer system according to the second embodiment has an appearance similar to the one according to the first embodiment and described above, although no cable is required to connect the keyboard device 1 and the PC main body 2. Instead, antennas and other elements for establishing a wireless connection between them need to be introduced. The DataPlay in FIG. 2A, the disk drive in FIG. 2B, the structure of the lateral side of the keyboard device shown in FIG. 3 and the display section shown in FIG. 4 are equally applicable to this embodiment.

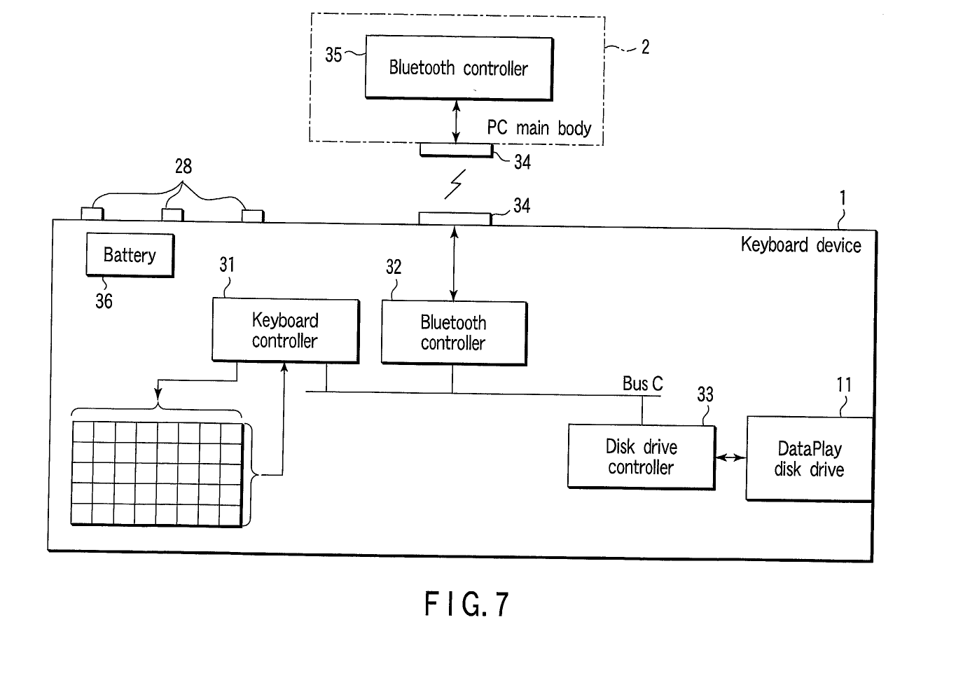

FIG. 7 is a schematic block diagram illustrating the internal configuration of the keyboard device according to a second embodiment of the present invention. The components that are the same as or similar to those of the first embodiment (FIG. 5) are denoted respectively by the same reference symbols and will not be described any further.

A keyboard controller 31 of the keyboard device 1 is connected to bus C and controls the input keys (keyboard) of the keyboard device 1. When one or more of the input keys (keyboard) is depressed, the keyboard controller 31 transmits corresponding data to the PC main body 2 by way of the corresponding data bus C and Bluetooth controller 32. When, on the other hand, it receives a signal for invalidating the key input by way of the bus C it controls the operation of the keyboard so as to invalidate the key input.

The Bluetooth controller 32 is also connected to the bus C and provided with a functional feature of controlling a keyboard conforming to the Bluetooth Standard. The Bluetooth controller 32 is also connected to the Bluetooth controller 35 arranged in the PC main body 2 by way of antenna 34. The Bluetooth controller 32 is additionally connected to a disk drive controller 33 by way of the bus C. Thus, the Bluetooth controller 32 is adapted to handle exchanges of data between the keyboard controller 31 and the Bluetooth controller 35, between the Bluetooth controller 35 and the disk drive controller 33 and between the disk drive controller 33 and the keyboard controller 31.

The disk drive controller 33 is connected to the bus C and adapted to control the operation of the DataPlay in the disk drive 11. Upon receiving a request for accessing the DataPlay from the PC main body 2 by way of the Bluetooth controller 32, the disk drive controller 33 reads data from or writes data to the DataPlay and, if necessary, transmits data on the DataPlay to the PC main body 2 by way of the Bluetooth controller 32.

The antenna 34 is provided to establish a wireless connection between the Bluetooth controller 32 of the keyboard device 1 and the Bluetooth controller 35 of the PC main body 2 according to the Bluetooth Standard.

The Bluetooth controller 35 is arranged in the PC main body 2 and adapted to operate as a controller conforming to the Bluetooth Standard. The Bluetooth controller 35 is capable of wirelessly connecting to the Bluetooth controller 32 arranged in the keyboard device 1 by way of the antenna 34. With this connection arrangement, the Bluetooth controller 35 is adapted to handle exchanges of data with the keyboard controller 31 and also with the disk drive controller 33.

A battery 36 is used when the keyboard device 1 is not supplied with AC power particularly while the latter is being carried in order to be moved. However, it may alternatively be so arranged that the keyboard device 1 is always powered by the battery 36.

Connectors 28 of different types are provided for the purpose of connecting the keyboard device 1 to external devices conforming to respective interface standards. For instance, one of them may be used when the keyboard device 1 is moved to a site where an AV (audio/video) device is located and connected to the latter in order to read data from and/or write data to the DataPlay in the disk drive 11. In this case, the connector operates as an external AV terminal (adapted to NTSC signals).

As described above, the keyboard device 1 contains a single Bluetooth controller so that data may be exchanged between the keyboard controller 31 or the disk drive controller 33 of the keyboard device 1 and the Bluetooth controller 35 of the PC main body 2.

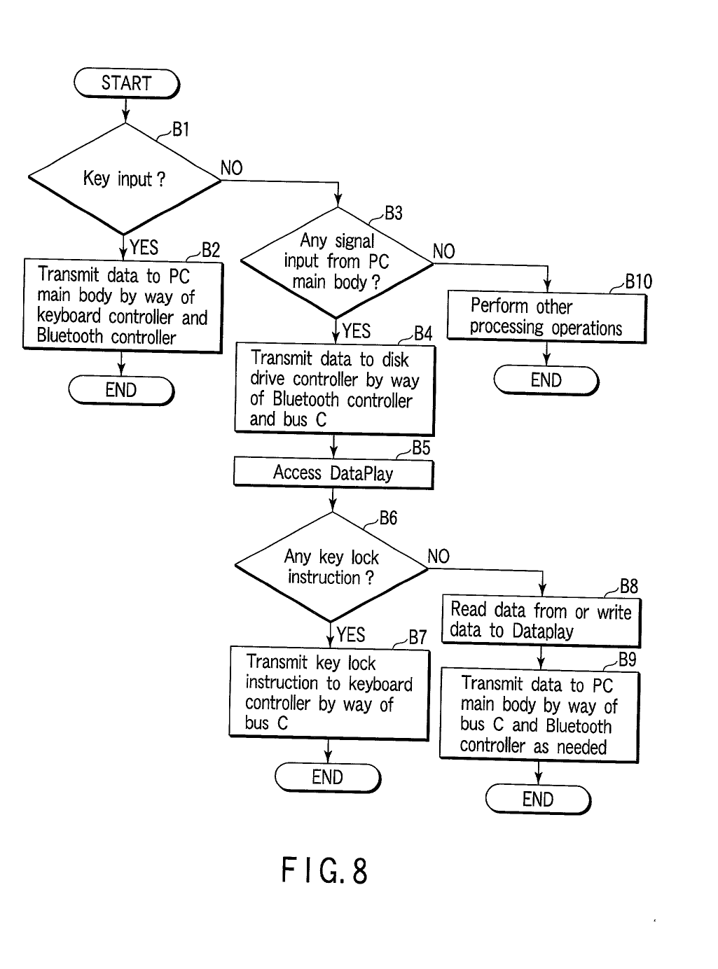

Now, the operation of the keyboard device according to the second embodiment will be described by referring to the flowchart of FIG. 8.

When a user key input operation takes place (Step B1), the corresponding data is transmitted from the keyboard controller 31 to the Bluetooth controller 32 by way of the bus C and also to the PC main body 2 by way of the antenna 34 (Step B2). As a result, the data input by the user is transmitted to the PC main body 2.

When, on the other hand, an access request signal for accessing the DataPlay is transmitted from the PC main body 2 to the Bluetooth controller 32 by way of the antenna 34 (Step B3), the corresponding data is transmitted from the Bluetooth controller 32 to the disk drive controller 33 by way of the bus C (Step B4).

As a result, the DataPlay in the disk drive 11 is accessed by the disk drive controller 33 (Step B5).

If the accessed DataPlay is a security-purpose DataPlay and hence a key lock instruction is detected (Step B6), the disk drive controller 33 notifies the keyboard controller 31 of the data representing the instruction by way of the bus C (Step B7). As a result, the key input of the user is invalidated by the keyboard controller 31.

If, on the other hand, the DataPlay accessed in Step B6 is an ordinary DataPlay and hence no key lock instruction is detected, the optical disc in the cartridge of the DataPlay is made to rotate and the data at the target recording position is read out or data is written to the target recording position under the control of the disk drive controller 33 (Step B8). If necessary, appropriate data stored in the DataPlay may be transmitted to the PC main body 2 by way of the bus C, the Bluetooth controller 32 and the antenna 34 (Step B9).

Also, if necessary, some other processing operation (e.g., exchange of data with an external device by way of one of the connectors 28) may be conducted (Step B10).

Thus, in addition to the advantages described above for the first embodiment, this embodiment also provides an advantage that the keyboard device 1 can be moved to a site where an AV device is located and connected to the latter in order to read data from and/or write data to the DataPlay in the disk drive 11. Furthermore, since, unlike the first embodiment, this embodiment does not require the use of a cable connecting itself and the PC main body, the entire system configuration can be simplified further.

### 3rd Embodiment

Next, the third embodiment of the present invention will be described below.

While the first embodiment includes USB controllers to form a computer system, and the second embodiment includes a Bluetooth controller to form a computer system, this third embodiment does not include any such controller to form a computer system.

A computer system according to the third embodiment has an appearance similar to the one shown in FIG. 1. Additionally, the DataPlay in FIG. 2A, the disk drive in FIG. 2B, the structure of the lateral side of the keyboard device shown in FIG. 3 and the display section shown in FIG. 4 are equally applicable to the first embodiment.

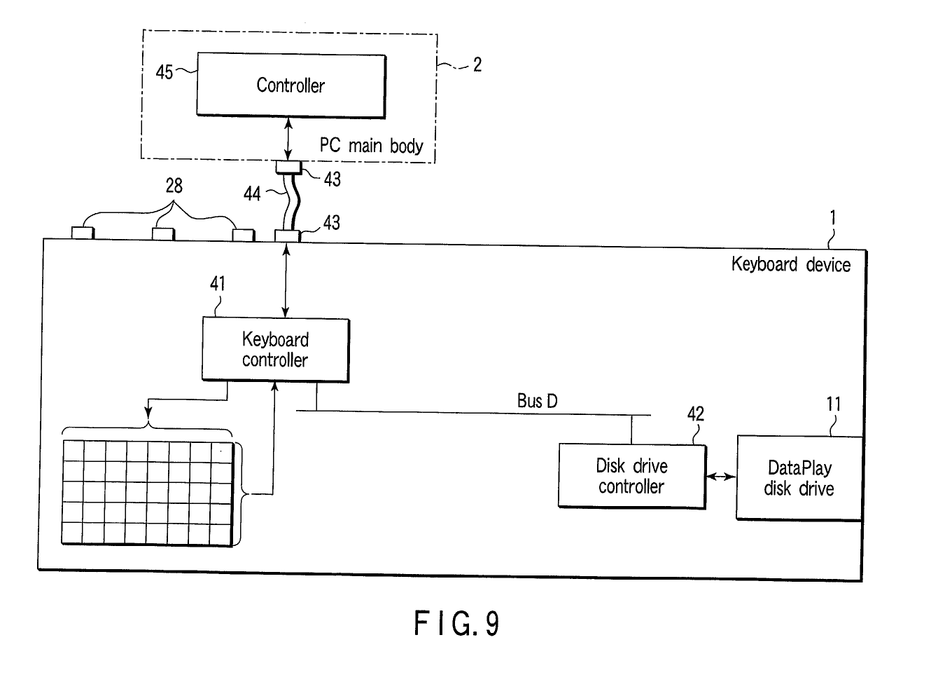

FIG. 9 is a schematic block diagram illustrating the internal configuration of the keyboard device according to a third embodiment of the present invention. The components that are the same as or similar to those of the first embodiment (FIG. 5) are denoted respectively by the same reference symbols and will not be described any further.

A keyboard controller 41 of the keyboard device 1 is connected to bus D and controls the input keys (keyboard) of the keyboard device 1. When one or more of the input keys (keyboard) is depressed, the keyboard controller 41 transmits corresponding data to the controller 45 of the PC main body 2 by way of the corresponding connectors 43 and cable 44. When, on the other hand, it receives a signal for invalidating the key input by way of the bus D it controls the operation of the keyboard so as to invalidate the key input. The keyboard controller 41 is also connected to a disk drive controller 42 by way of the bus D. Thus, with this connection arrangement, the keyboard controller 41 is adapted to handle exchanges of data between itself and the PC main body 2 and also between itself and the disk drive controller 42.

The disk drive controller 42 is connected to the bus D and adapted to control the operation of the DataPlay in the disk drive 11. Upon receiving a request for accessing the DataPlay from the PC main body 2 by way of the keyboard controller 41, the disk drive controller 42 reads data from or writes data to the DataPlay and, if necessary, transmits data on the DataPlay to the PC main body 2 by way of the keyboard controller 41.

The connectors 43 and the cable 44 shown in FIG. 9 are provided to connect the keyboard controller 41 arranged in the keyboard device 1 and the controller 45 of the PC main body 2.

The controller 45 is arranged in the PC main body 2 and connected to the keyboard controller 41 arranged in the keyboard device 1 by way of the connectors 43 and the cable 44. With this connection arrangement, the keyboard controller 41 is adapted to handle exchanges of data between itself and the disk drive controller 42.

Exchanges of data between the controller 45, the keyboard controller 41 and the disk drive controller 42 are conducted by using packets having a specific format. The controller transmitting packets causes the packets to contain control information, real data and also information indicating the address of the receiving controller and added to the headers of the packets before actually transmitting the packets. The controller receiving the packets determines if the packets are addressed to itself or not by inspecting the headers.

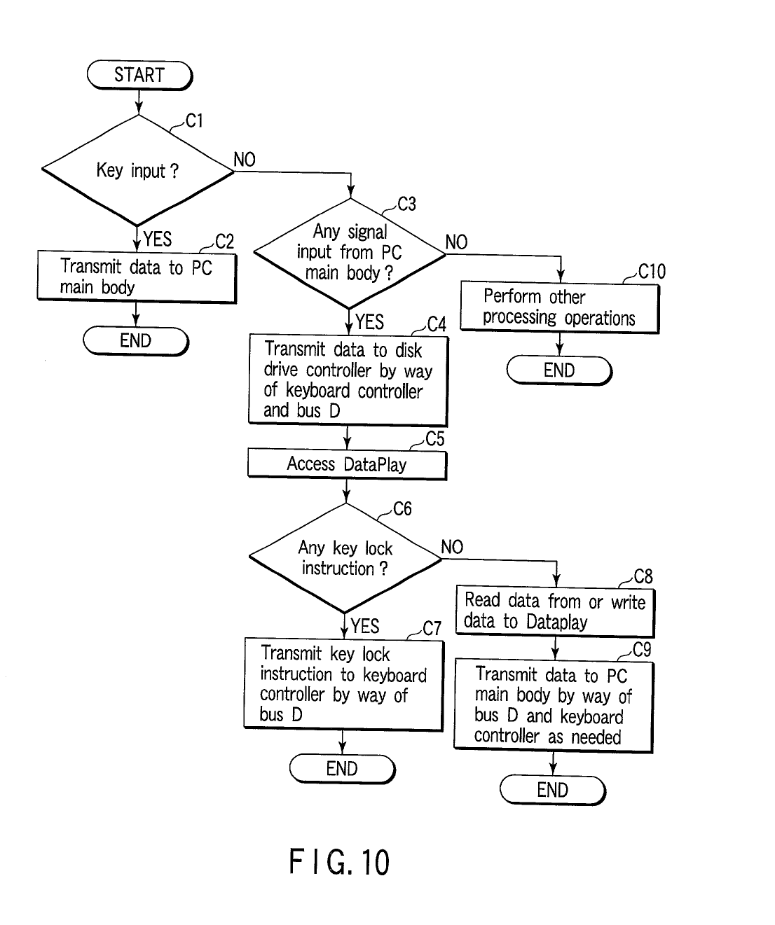

Now, the operation of the keyboard device according to the third embodiment will be described by referring to the flowchart of FIG. 10.

When a user key input operation takes place (Step C1), the corresponding data is transmitted from the keyboard controller 41 to the PC main body 2 by way of the connectors 43 and the cable 44 (Step C2). As a result, the data input by the user is transmitted to the PC main body 2.

When, on the other hand, an access request signal for accessing the DataPlay is transmitted from the PC main body 2 to the keyboard controller 41 by way of the connectors 43 and the cable 41 (Step C3), the corresponding data is transmitted from the keyboard controller 41 to the disk drive controller 42 by way of the bus D (Step C4).

As a result, the DataPlay in the disk drive 11 is accessed by the disk drive controller 42 (Step C5).

If the accessed DataPlay is a security-purpose DataPlay and hence a key lock instruction is detected (Step C6), the disk drive controller 42 notifies the keyboard controller 41 of the data representing the instruction by way of the bus D (Step C7). As a result, the key input of the user is controlled to be invalidated by the keyboard controller 41.

If, on the other hand, the DataPlay accessed in Step C6 is an ordinary DataPlay and hence no key lock instruction is detected, the optical disc in the cartridge of the DataPlay is made to rotate and the data at the target recording position is read out or data is written to the target recording position under the control of the disk drive controller 42 (Step C8). If necessary, appropriate data stored in the DataPlay may be transmitted to the PC main body 2 by way of the bus D, the keyboard controller 41, the connectors 43 and the cable 44 (Step C9).

Also, if necessary, some other processing operation (e.g., exchange of data with an external device by way of one of the connectors 28) may be conducted (Step C10).

Thus, in addition to the advantages described above for the first and second embodiments, this embodiment also provide an advantage that a computer system can be formed without using any USB controllers or Bluetooth controllers.

In the following description on the fourth to sixth embodiments given by referring to the corresponding drawings, the components that are the same as or similar to those of the first to third embodiments are denoted respectively by the same reference symbols.

### 4th Embodiment

Now, the fourth embodiment of the present invention will be described below.

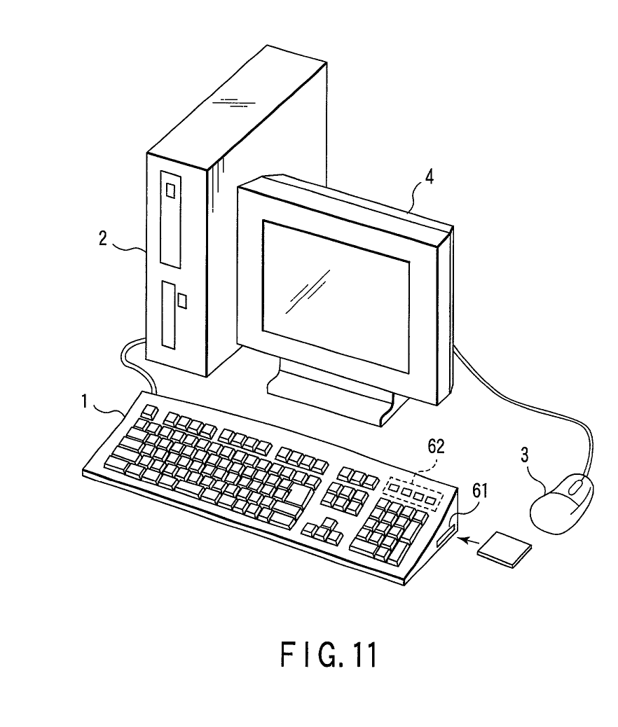

FIG. 11 is a schematic perspective view of a desktop type computer system according to a fourth embodiment of the present invention. Note, however, that the illustrated computer system can also be used in second and third embodiments of the present invention, which will be described later.

The computer system includes a keyboard device 1, a computer main body 2, a mouse 3 and a display unit 4.

The keyboard device 1 is an input device through which the user inputs data. The keyboard device 1 is provided with not only a number of keys thereon that are arranged in a known manner but also a PC card slot 61 for receiving a PC card and a display section 62 including an indicator (lamp) for notifying the user of the current status of operation of the PC card (the status of the disk driven in the PC card) as characteristics of this embodiment. The keyboard device 1 is connected to the computer main body 2 by way of a USB cable compatible with a USB (universal serial bus).

PC cards that can be loaded into the PC card slot 61 include those provided with a magnetic disk drive containing a magnetic disk therein and those for security purposes (optional cards) that are used when the user's key input needs to be invalidated.

The computer main body 2 contains therein a computer that controls the entire system and a hard disk drive, along with drives for driving respective removable recording media such as a floppy disk and a CD-ROM. The computer main body carries out a known process for displaying information on the display unit 4 in accordance with signals coming from the keyboard device 1 but also a process of (read data from, write data to and erase data from) the PC card in the PC card slot 61 of the keyboard device 1.

The mouse 3 is also an input device that the user uses for data input operations and is connected to the computer main body 2 by way of a cable. The display unit 4 is adapted to display various pieces of information and is connected to the computer main body 2 by way of a cable.

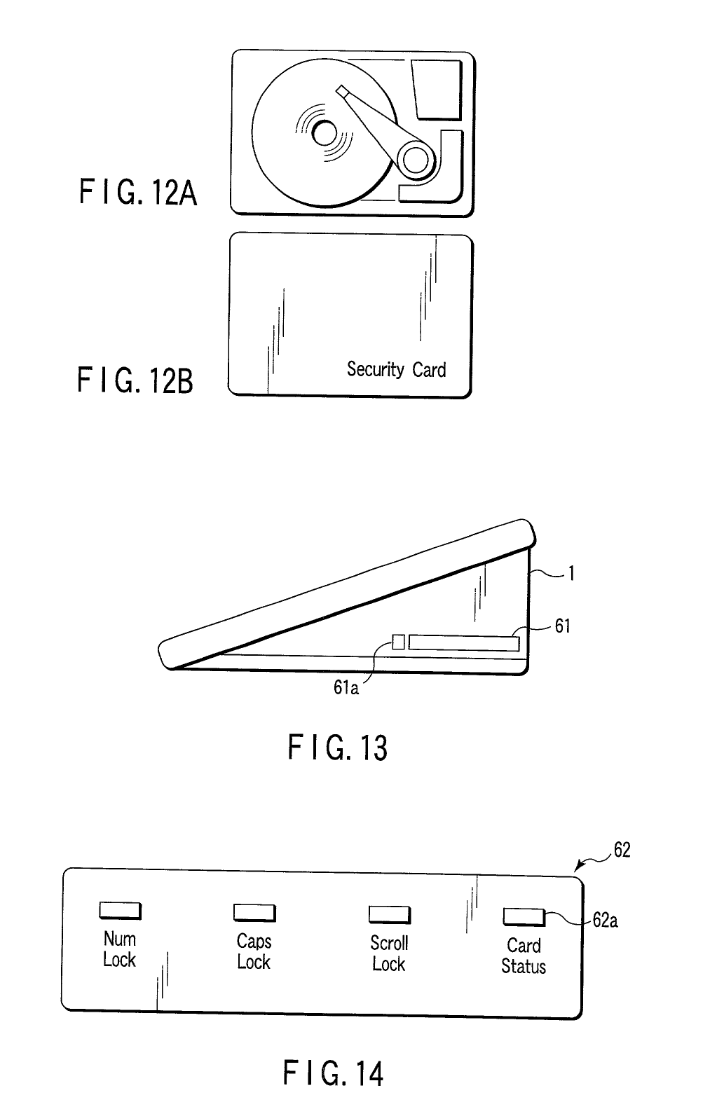

FIGS. 12A and 12B are schematic illustrations of PC cards that are used in the same embodiment.

A PC card shown in FIG. 12A is a card conforming to the PCMCIA (Personal Computer Memory Card International Association) standard and may typically be a PC card provided with a 1.8-inch type magnetic disk drive (hard disk drive) for driving a magnetic disk therein.

A PC card shown in FIG. 12B may be one to be used to invalidate the pending key input by the user for security purposes. For instance, when multimedia data is retrieved from an ordinary PC card by means of this system, the user can load the data stored in a security-purpose PC card to unlock the input keys on the keyboard device 1 in advance so that the succeeding data retrieval operation may not be obstructed.

While the embodiment is described here in terms of a PC card provided with a magnetic disk drive, it may be replaced by some other recording medium conforming to some other standard, if it is adapted to be made to rotate.

Furthermore, beside the example shown in FIGS. 12A and 12B, PC cards for various different applications including those for radio transmission may be used in this embodiment.

FIG. 13 is a schematic lateral view illustrating the location of the PC card slot 61 of the keyboard device 1 according to the same embodiment.

As shown in FIG. 13, the PC card slot 61 is arranged at a rear and lower position of a lateral side of the keyboard device 1. With such a positional arrangement, the disk in the PC card is minimally affected by any vibrations that may take place while the disk in the PC card is driven.

Additionally, since the PC card slot is placed in a space produced from the tilted arrangement of the keyboard device, it does not require any additional space to be provided for it. Furthermore, the PC card slot does not provide any obstruction relative to the cables and the antenna of the computer system nor aesthetically damage the appearance of the computer system.

The keyboard device 1 is provided with an ejector (or a lever) 61a arranged near the PC card slot 61 on a lateral side of the keyboard device 1. Since the hands of the user operating the computer system are normally placed on the keyboard device and the PC card slot 61 and the ejector 61a are located very close to one of the hands of the user, the above positional arrangement is very convenient to the user when he or she inserts or takes out the PC card.

FIG. 14 is a view illustrating in detail the display section 62 of the keyboard device 1 according to the same embodiment.

As shown in FIG. 14, the display section of the keyboard device 1 is provided with indicators corresponding respectively to the features of NumLock, CapsLock and ScrollLock as well as a disk status indicator 62a for notifying the user of the status of the PC card in the PC card slot 61. The indicator 62a may typically flash when the PC card in the PC card slot 61 is accessed.

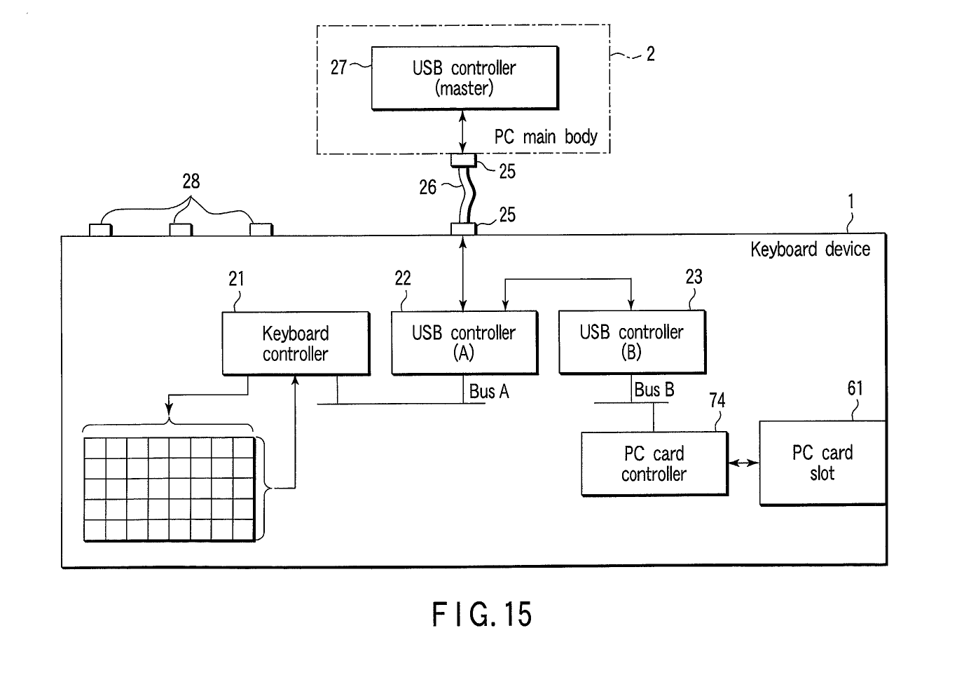

FIG. 15 is a schematic block diagram illustrating the internal configuration of the keyboard device according to a fourth embodiment of the present invention. The components denoted respectively by reference symbols 21 to 23 and 25 to 28 are the same as or similar to those of FIG. 5 and hence will not be described here any further.

The PC card controller 74 is connected to the bus B and adapted to control the operation of the PC card in the PC card slot 61. Upon receiving a request for accessing the PC card from the PC main body 2 by way of the USB controller (A) 22 and the USB controller (B) 23, the PC card controller 74 reads data from, writes data to or erase data from the PC card in the PC card slot 61 and, if necessary, transmits data on the PC card to the PC main body 2 by way of the USB controller (A) 22 and the USB controller (B) 23.

As described above, the keyboard device 1 contains a number of hubs (the USB controller (A) 22 and the USB controller (B) 23) so that data may be exchanged between the keyboard controller 21 or the PC card controller 74 of the keyboard device 1 and the USB controller 27 of the PC main body 2.

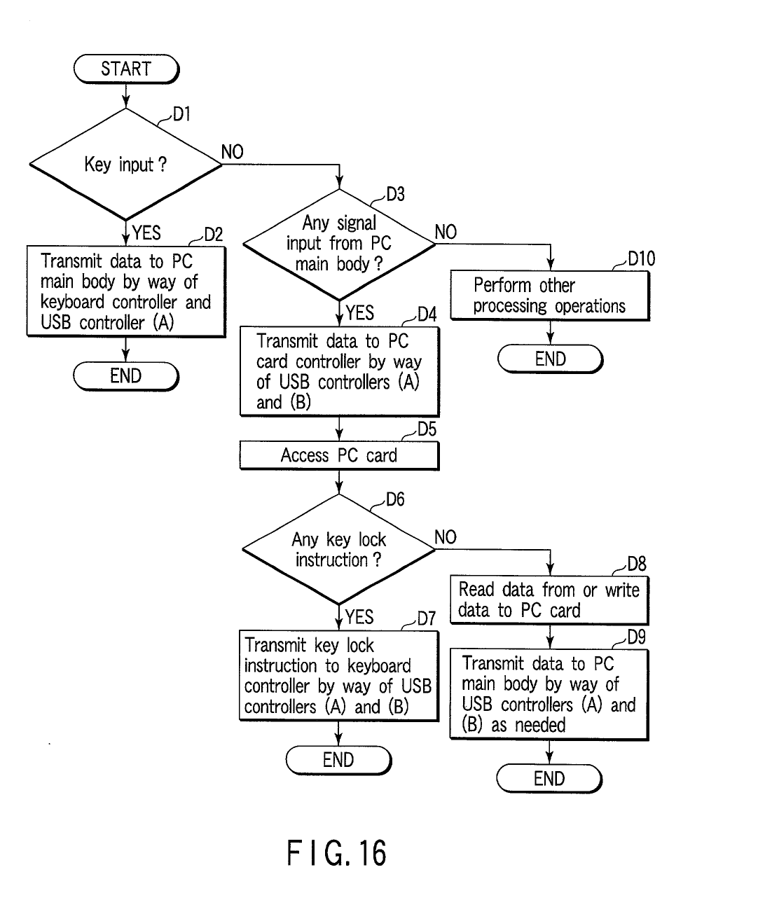

Now, the operation of the keyboard device according to the fourth embodiment will be described by referring to the flowchart of FIG. 16.

When a user key input operation takes place (Step D1), the corresponding data is transmitted from the keyboard controller 21 to the USB controller (A) 22 by way of the bus A and also to the PC main body 2 by way of the USB connectors 25 and the USB cable 26 (Step D2). As a result, the data input by the user is transmitted to the PC main body 2.

When, on the other hand, an access request signal for accessing the PC card is transmitted from the PC main body 2 to the USB controller (A) 22 by way of the USB connectors 25 and the USB cable 26 (Step D3), the corresponding data is transmitted from the USB controller (A) 22 to the USB controller (B) 23 and further to the PC card controller 74 by way of the bus B (Step D4).

As a result, the PC card in the PC card slot 61 is accessed by the PC card controller 74 (Step D5).

If the accessed PC card is a security-purpose PC card and hence a key lock instruction is detected (Step D6), the PC card controller 74 notifies the keyboard controller 21 of the data representing the instruction by way of the bus B, the USB controller (B) 23, the USB controller (A) 22 and the bus A (Step D7). As a result, the key input of the user is invalidated by the keyboard controller 21.

If, on the other hand, the PC card accessed in Step D6 is an ordinary PC card that may typically carry a magnetic disk drive and hence no key lock instruction is detected, the disk in the PC card is made to rotate and the data at the target recording position is read out or data is written to the target recording position under the control of the PC card controller 74 (Step D8). If necessary, appropriate data stored in the PC card may be transmitted to the PC main body 2 by way of the bus B, the USB controller (B) 23, the USB controller (A) 22, the USB connectors 25 and the USB cable 26 (Step D9).

Also, if necessary, some other processing operation (e.g., exchange of data with an external device by way of one of the connectors 28) may be conducted (Step D10).

While the system incorporating the fourth embodiment includes controllers, connectors and a cable conforming to the USB Standard in the above description, the controllers, the connectors and the cables may alternatively conform to the IEEE1394 Standard or some other appropriate standard. The above description of the processing procedure may equally apply if such alternative components are used.

While a pair of hubs is provided in the embodiment of the keyboard device in the above description, the embodiment is not limited thereto and three or more than three hubs may alternatively be provided to expand the functional scope of the embodiment.

Thus, with the fourth embodiment of the keyboard device including a plurality of hubs, the use of a single cable is sufficient for exchanges of data between the keyboard device and the PC main body to simplify the system configuration and reduce the cost.

Additionally, as a keyboard device that is relatively less apt to be influenced by external vibrations is adapted to handle a PC card in the embodiment, a PC card including a disk, an arm, a suspension system and a head that are highly sensitive to vibrations can safely be used in the keyboard device.

Further, since the PC card slot is arranged at a rear and lower position of a lateral side of the keyboard device, the disk in the PC card is minimally affected by any vibrations that may take place while the PC card is driven.

Further still, since the PC card slot is placed in a space produced from the tilted arrangement of the keyboard device, it does not require any additional space to be provided for it. Furthermore, the PC card slot does not provide any obstruction relative to the cables and the antenna of the computer system nor aesthetically damage the appearance of the computer system.

Since the hands of the user operating the computer system are normally placed on the keyboard device 1, the PC card slot and the ejector are located very close to one of the hands of the user, the above positional arrangement of the PC card slot is very convenient to the user when he or she inserts or takes out the PC card.

Finally, since a PC card is a relatively small removable recording medium, the space occupied by the disk drive in the keyboard device can be minimized.

### 5th Embodiment

Next, the fifth embodiment of the present invention will be described below.

While the fourth embodiment includes USB controllers conforming to the USB Standard, and a computer system formed by using the first embodiment is described above, the fifth embodiment includes a Bluetooth controller, and a computer system formed by using the fifth embodiment will be described below.

A computer system according to the fifth embodiment has an appearance similar to the one according to the fourth embodiment and described above by referring to FIG. 11, although no cable is required to connect the keyboard device 1 and the PC main body 2. Instead, antennas and other elements for establishing a wireless connection between them need to be introduced. The PC card in FIGS. 12A and 12B, the structure of the lateral side of the keyboard device shown in FIG. 13 and the display section shown in FIG. 14 are equally applicable to this embodiment.

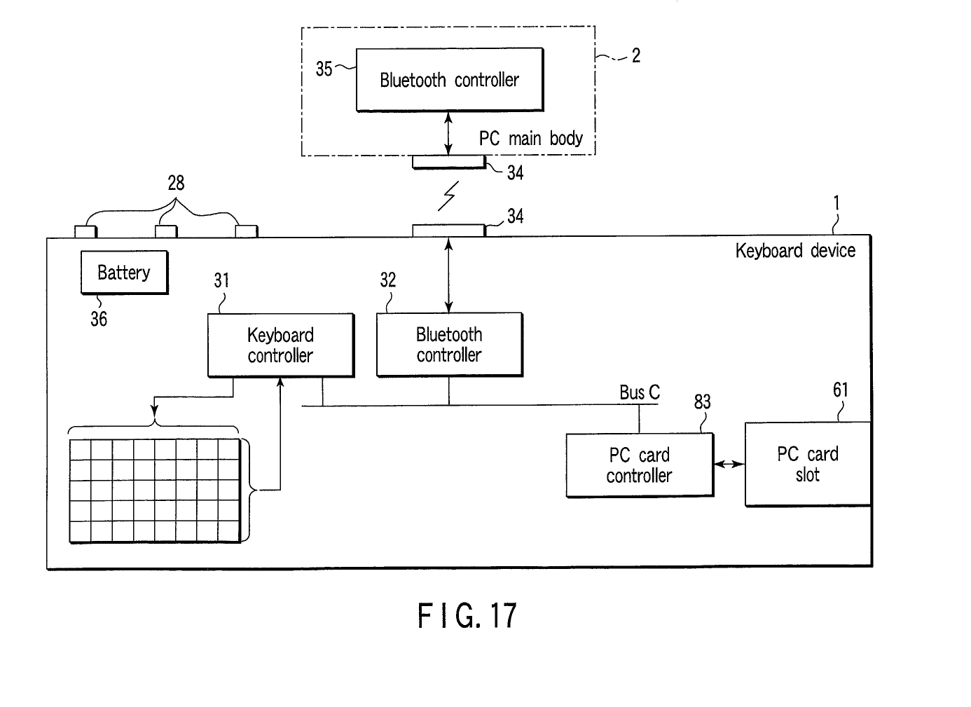

FIG. 17 is a schematic block diagram illustrating the internal configuration of the keyboard device according to a fifth embodiment of the present invention. The components that are the same as or similar to those of the fourth embodiment (FIG. 15) are denoted respectively by the same reference symbols and will not be described any further.

Furthermore, the components denoted respectively by reference symbols 31, 32 and 34 to 36 are the same as or similar to those of FIG. 7 and hence will not be described here any further.

The PC card controller 83 is connected to the bus C and adapted to control the operation of the PC card in the PC card slot 61. Upon receiving a request for accessing the PC card from the PC main body 2 by way of the Bluetooth controller 32, the PC card controller 83 reads data from or writes data to the PC card and, if necessary, transmits data on the PC card to the PC main body 2 by way of the Bluetooth controller 32.

As described above, the keyboard device 1 contains a single Bluetooth controller so that data may be exchanged between the keyboard controller 31 or the PC card controller 83 of the keyboard device 1 and the Bluetooth controller 35 of the PC main body 2.

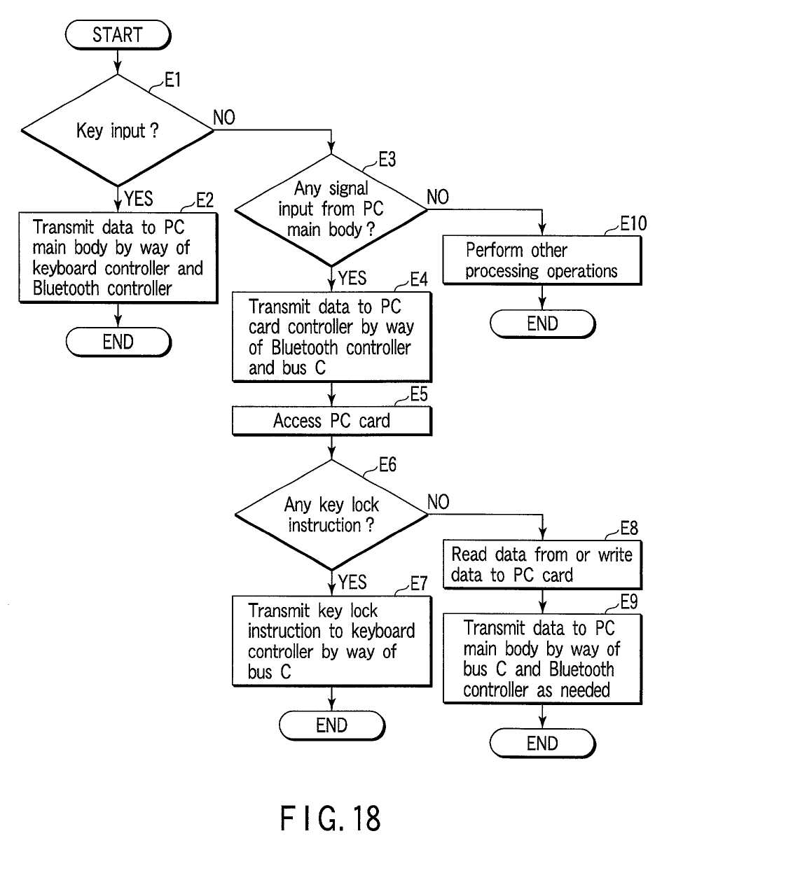

Now, the operation of the keyboard device according to the fifth embodiment will be described by referring to the flowchart of FIG. 18.

When a user key input operation takes place (Step E1), the corresponding data is transmitted from the keyboard controller 31 to the Bluetooth controller 32 by way of the bus C and also to the PC main body 2 by way of the antenna 34 (Step E2). As a result, the data input by the user is transmitted to the PC main body 2.

When, on the other hand, an access request signal for accessing the PC card is transmitted from the PC main body 2 to the Bluetooth controller 32 by way of the antenna 34 (Step E3), the corresponding data is transmitted from the Bluetooth controller 32 to the PC card controller 83 by way of the bus C (Step E4).

As a result, the PC card in the PC card slot 61 is accessed by the PC card controller 83 (Step E5).

If the accessed PC card is a security-purpose PC card and hence a key lock instruction is detected (Step E6), the PC card controller 83 notifies the keyboard controller 31 of the data representing the instruction by way of the bus C (Step E7). As a result, the key input of the user is invalidated by the keyboard controller 31.

If, on the other hand, the PC card accessed in Step E6 is an ordinary PC card typically carrying a magnetic disk and hence no key lock instruction is detected, the disk in the PC card is made to rotate and the data at the target recording position is read out or data is written to the target recording position under the control of the PC card controller 83 (Step E8). If necessary, appropriate data stored in the PC card may be transmitted to the PC main body 2 by way of the bus C, the Bluetooth controller 32 and the antenna 34 (Step E9).

Also, if necessary, some other processing operation (e.g., exchange of data with an external device by way of one of the connectors 28) may be conducted (Step E10).

Thus, in addition to the advantages described above for the fourth embodiment, this embodiment also provides an advantage that the keyboard device 1 can be moved to a site where an AV device is located and connected to the latter in order to read data from and/or write data to the PC card in the disk drive. Furthermore, since, unlike the fourth embodiment, this embodiment does not require the use of a cable connecting itself and the PC main body, the entire system configuration can be simplified further.

### 6th Embodiment

Next, the sixth embodiment of the present invention will be described below.

While the fourth embodiment includes USB controllers to form a computer system, and the fifth embodiment includes a Bluetooth controller to form a computer system, this sixth embodiment does not include any such controller to form a computer system.

A computer system according to the sixth embodiment has an appearance similar to the one shown in FIG. 11. Additionally, the PC card in FIGS. 12A and FIG. 12B, the structure of the lateral side of the keyboard device shown in FIG. 13 and the display section shown in FIG. 14 are equally applicable to this embodiment.

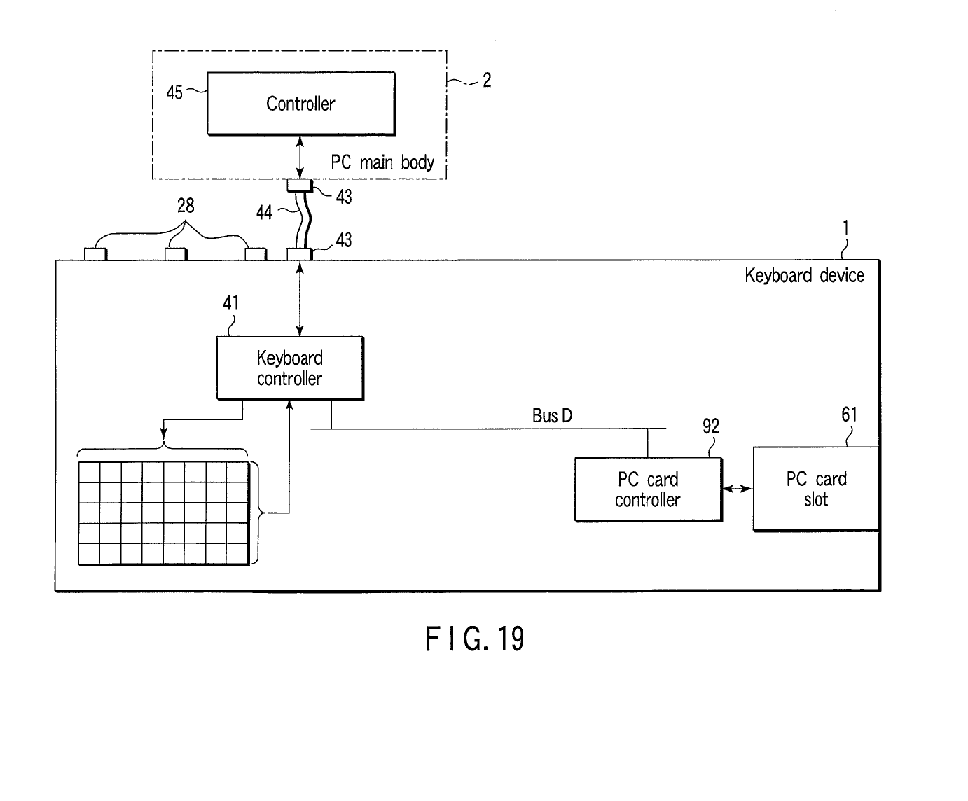

FIG. 19 is a schematic block diagram illustrating the internal configuration of the keyboard device according to a sixth embodiment of the present invention. The components that are the same as or similar to those of the fourth embodiment (FIG. 15) are denoted respectively by the same reference symbols and will not be described any further.

Furthermore, the components denoted respectively by reference symbols 41 and 43 to 45 are the same as or similar to those of FIG. 9 and hence will not be described here any further.

The PC card controller 92 is connected to the bus D and adapted to control the operation of the PC card in the PC card slot 61. Upon receiving a request for accessing the PC card from the PC main body 2 by way of the keyboard controller 41, the PC card controller 92 reads data from, writes data to or erase data from the PC card and, if necessary, transmits data on the PC card to the PC main body 2 by way of the keyboard controller 41.

Exchanges of data between the controller 45, the keyboard controller 41 and the PC card controller 92 are conducted by using packets having a specific format. The controller transmitting packets causes the packets to contain control information, real data and also information indicating the address of the receiving controller and added to the headers of the packets before actually transmitting the packets. The controller receiving the packets determines if the packets are addressed to itself or not by examining the headers.

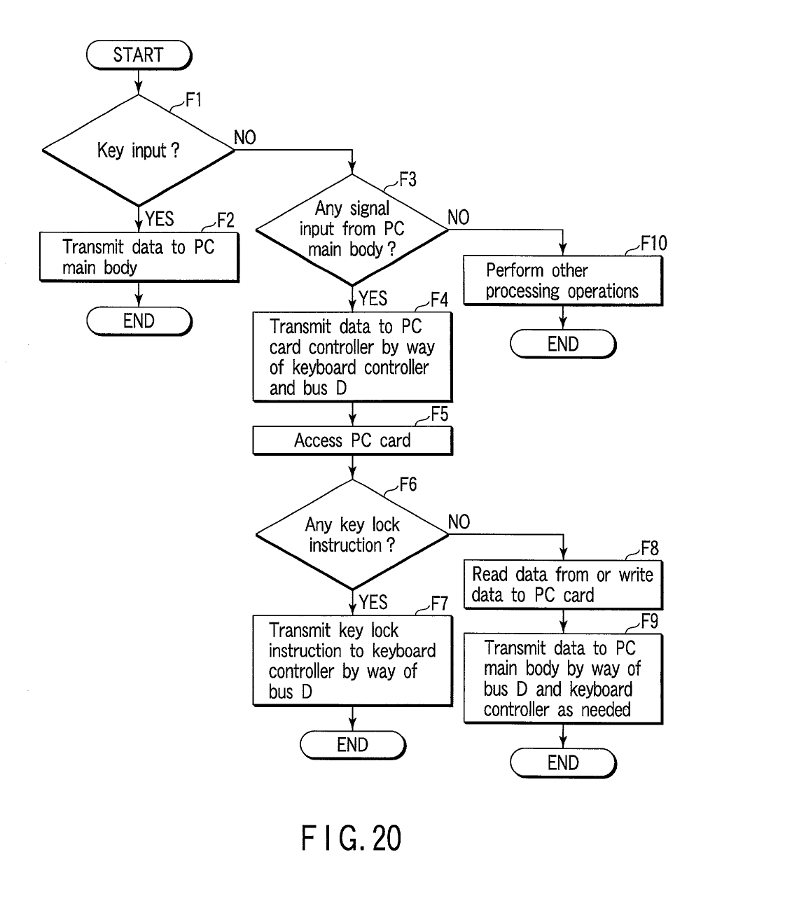

Now, the operation of the keyboard device according to the sixth embodiment will be described by referring to the flowchart of FIG. 20.

When a user key input operation takes place (Step F1), the corresponding data is transmitted from the keyboard controller 41 to the PC main body 2 by way of the connectors 43 and the cable 44 (Step F2). As a result, the data input by the user is transmitted to the PC main body 2.

When, on the other hand, an access request signal for accessing the PC card is transmitted from the PC main body 2 to the keyboard controller 41 by way of the connectors 43 and the cable 41 (Step F3), the corresponding data is transmitted from the keyboard controller 41 to the PC card controller 92 by way of the bus D (Step F4).

As a result, the PC card in the PC card slot 61 is accessed by the PC card controller 92 (Step F5).

If the accessed PC card is a security-purpose PC card and hence a key lock instruction is detected (Step F6), the PC card controller 92 notifies the keyboard controller 41 of the data representing the instruction by way of the bus D (Step F7). As a result, the key input of the user is invalidated by the keyboard controller 41.

If, on the other hand, the PC card accessed in Step F6 is an ordinary PC card typically carrying a magnetic disk and hence no key lock instruction is detected, the disk in the PC card is made to rotate and the data at the target recording position is read out or data is written to the target recording position under the control of the PC card controller 92 (Step F8). If necessary, appropriate data stored in the PC card may be transmitted to the PC main body 2 by way of the bus D, the keyboard controller 41, the connectors 43 and the cable 44 (Step F9).

Also, if necessary, some other processing operation (e.g., exchange of data with an external device by way of one of the connectors 28) may be conducted (Step F10).

Thus, in addition to the advantages described above for the fourth and fifth embodiments, this embodiment also provide an advantage that a computer system can be formed without using any USB controllers or Bluetooth controllers.

The present invention is by no means limited to the above described embodiments, which may be modified and altered appropriately without departing from the scope of the present invention. For example, while each of the above described embodiments is adapted to handle a DataPlay or a PC card carrying a magnetic disk drive, the present invention is not limited thereto and may alternatively be adapted to handle a removable recording medium of any other type.

As described above in detail, the present invention provides a keyboard device that can effectively and efficiently process data for a removable recording medium.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A keyboard device capable of exchanging data with a computer main body, said device comprising:
a disk drive including
a slot configured to receive an insertion of a cartridge containing a disciform recording medium having recording surface on both sides, said slot being capable of receiving the disciform recording medium even if the disciform recording medium is turned upside down, and
a carriage having a head and pivoting an arc to read data from or writing data to the recording surface of the disciform recording medium via the head; and
a controller configured to control said disk drive.

2. The device according to claim 1, wherein said disk drive is configured to drive an optical disc in the cartridge.

3. The device according to claim 1, wherein said disk drive is arranged in a space produced from a tilted arrangement of said keyboard device.

4. The device according to claim 1, further comprising an indicator configured to indicate a status of operation of the recording medium in said disk drive.

5. The device according to claim 1, wherein the key input of the user is invalidated when a specific recording medium is loaded in said disk drive.

6. A keyboard device capable of exchanging data with a computer main body, said device comprising:
a keyboard controller;
a first USB controller connected to said keyboard controller and capable of being connected to a USB controller in said computer main body;
a disk drive including
a slot configured to receive an insertion of a cartridge containing a disciform recording medium having recording surface on both sides, said slot being capable of receiving the disciform recording medium even if the disciform recording medium is turned upside down, and
a carriage having a head and pivoting an arc to read data from or writing data to the recording surface of the disciform recording medium via the head;
a disk drive controller configured to control said disk drive; and
a second USB controller connected to said disk drive controller, said second USB controller being hub-connected to said first USB controller.

7. A keyboard device capable of exchanging data with a computer main body, said device comprising:
a keyboard controller;
a Bluetooth controller connected to said keyboard controller and capable of being connected to a Bluetooth controller in said computer main body;
a disk drive including
a slot configured to receive an insertion of a cartridge containing a disciform recording medium having recording surface on both sides, said slot being capable of receiving the disciform recording medium even if the disciform recording medium is turned upside down, and
a carriage having a head and pivoting an arc to read data from or writing data to the recording surface of the disciform recording medium via the head; and
a disk drive controller configured to control said disk drive, said disk drive controller being connected to said Bluetooth controller that is connected to said keyboard controller.

8. A keyboard device capable of exchanging data with a computer main body, said device comprising:
a slot configured to receive an insertion of a card containing a disk drive and a disciform recording medium driven by the disk drive; and
a controller configured to control said card.

9. A device according to claim 8, wherein said slot is configured to receive a PC card.

10. A device according to claim 8, wherein said slot is arranged in a space produced from a tilted arrangement of said keyboard device.

11. The device according to claim 8, further comprising an indicator configured to indicate a status of operation of the card in said slot.

12. The device according to claim 8, wherein the key input of the user is invalidated when a specific card is inserted into said slot.

13. A keyboard device capable of exchanging data with a computer main body, said device comprising:
a keyboard controller;
a first USB controller connected to said keyboard controller and capable of being connected to a USB controller in said computer main body;
a slot configured to receive an insertion of a card containing a disk drive and a disciform recording medium driven by the disk drive;
a card controller configured to control the card; and
a second USB controller connected to said card controller, said second USB controller being hub-connected to said first USB controller.

14. A keyboard device capable of exchanging data with a computer main body, said device comprising:
a keyboard controller;
a Bluetooth controller connected to said keyboard controller and capable of being connected to a Bluetooth controller in said computer main body;
a slot configured to receive an insertion of a card containing a disk drive and a disciform recording medium driven by the disk drive; and
a card controller configured to control the card, said card controller being connected to said Bluetooth controller that is connected to said keyboard controller.
